(19) United States
(12) Patent Application Publication
(10) Pub. No.: US 2011/0233197 A1
(43) Pub. Date: Sep. 29, 2011

(54) METHOD FOR MANUFACTURING OPTICAL MODULE

(75) Inventor: Yasushi HARANO, Sakura-shi (JP)

(73) Assignee: FUJIKURA LTD., Tokyo (JP)

(21) Appl. No.: 13/073,433

(22) Filed: Mar. 28, 2011

(30) Foreign Application Priority Data
Mar. 29, 2010 (JP) 2010-075379

(51) Int. Cl. H05B 6/10

(52) U.S. Cl. 219/636

(57) ABSTRACT

A method of the present invention for manufacturing an optical module is a method for manufacturing an optical module including an optical fiber and an optical fiber insertion pipe in which the optical fiber is inserted, the method including a hermetic sealing step in which the optical fiber insertion pipe is hermetically sealed, the hermetic sealing step including: a providing step in which a guide is provide to a side surface of the optical fiber insertion pipe; and a heating step in which the optical fiber insertion pipe is heated to melt a wire solder contained in the guide. As such, the method for manufacturing an optical module is provided in which the hermetic sealing is improved in performance.

This Nonprovisional application claims priority under 35 U.S.C. §119(a) on Patent Application No. 2010-075379 filed in Japan on Mar. 29, 2010, the entire contents of which are hereby incorporated by reference.

### TECHNICAL FIELD

The present invention relates to a method for manufacturing an optical module including an optical fiber.

### BACKGROUND ART

Generally, an optical module is configured so that a light-emitting device (such as LD, LED, and the like) is housed in a housing and an optical fiber which is optically coupled to the light-emitting device extends outside the housing via an optical fiber insertion pipe.

Regarding such an optical module, Patent Literature 1 discloses a method for fixing an optical fiber which extends outside an optical module. According to the disclosure by the patent Literature 1, there is provided an optical fiber insertion pipe having a hole provided in its side part. The optical fiber insertion pipe receives therein one end of an optical fiber. Then, a solder chip is provided in the hole provided in the side part of the optical fiber insertion pipe. Subsequently, laser welding or high-frequency induction heating is carried out so that the optical fiber is soldered to the optical fiber insertion pipe. This realizes fixing of the optical fiber. Generally, a soldering part of the optical fiber, via which soldering part the optical fiber is soldered and fixed to the optical fiber insertion pipe, is coated with metal film coating. This allows the optical fiber to be solderable with the solder. Unlike conventional connecting by use of an adhesive agent, such soldering poses no risk of aging deterioration. Further, soldering can be finished within a short time. With such advantages, this method employing the soldering is suitable for mass production of optical modules.

Light-emitting devices are very vulnerable to moisture, dust, and the like entering from the outside. As such, when contaminated therewith, the light-emitting devices may malfunction or greatly deteriorate in terms of reliability. In order to prevent this, it is necessary to take the following measure in manufacturing of an optical module. Specifically, it is necessary to hermetically seal the optical module so as to completely keep a light-emitting device from being exposed to the outside.

### Citation List

Patent Literature 1

Japanese Patent Application Publication, Tokukaihei, No. 2-64608 A (Publication Date: Mar. 5, 1990)

### SUMMARY OF INVENTION

### Technical Problem

Inventors of the present invention, in effort of improving optical module manufacturing, studied how to improve performance in a hermetic sealing step in which an optical module is hermetically sealed. Then, the inventors of the present invention noticed that a solder supplying method of the patent Literature 1 was useful for improving the performance in the hermetic sealing step.

As such, the inventors of the present invention diligently studied how to hermetically seal an optical fiber insertion pipe by soldering an optical fiber in an optical fiber insertion pipe with a solder supplied to a hole (hereinafter referred to as a feed hole) provided in a side part of the optical fiber insertion pipe. As a result of the diligent study, the inventors of the present invention found that the method, which simply supplies the solder to the feed hole, has a limitation that it is impossible to achieve practical hermetic sealing.

Specifically, the inventors of the present invention thought that it is preferable to use a normal wire solder as a solder material supplied for the hermetic sealing. In an hermetic sealing step employing a wire solder, the wire solder is supplied in the feed hole of the optical fiber insertion pipe being heated by, for example, high-frequency induction heating. The wire solder thus provided in the feed hole is melted and fills the optical fiber insertion pipes, and this realizes the hermetic sealing of the optical fiber insertion pipe. However, this type of the hermetic sealing step has a drawback that, when the wire solder is brought closer to the feed hole, a temperature of the wire solder is increased by heat conducted from the optical fiber insertion pipe being heated. As the temperature of the wire solder is increased, the wire solder becomes softened and/or melted. The solder wire thus softened is bent so easily that it is difficult to press down the wire solder to the feed hole by applying a force. In such circumstances, it is difficult to feed the wire solder. Also, it is difficult to accurately feed the wire solder thus melted.

The present invention is made in view of the problem, and an object of the present invention is to provide a method for manufacturing an optical module, which method realizes improved performance of hermetic sealing.

### Solution to Problem

In order to attain the object, a method of the present invention for manufacturing an optical module including an optical fiber and an optical fiber insertion pipe in which the optical fiber is inserted, the method including a hermetic sealing step in which the optical fiber insertion pipe is hermetically sealed, the hermetic sealing step including: a providing step in which a wire solder container member, (i) which has an opening and (ii) in which a wire solder is contained, is provided to a side surface of the optical fiber insertion pipe so that the opening of the wire solder container member faces a feed hole provided in the side surface of the optical fiber insertion pipe; and a heating step in which the optical fiber insertion pipe is heated to melt the wire solder that is contained in the wire solder container member provided in the providing step.

For example, in a case where the wire solder container member has a container-like shape in which the wire solder container member has a single opening, it may be arranged so that in the providing step, the solder container member in which the wire solder is contained in advance is provided to the side surface of the optical fiber insertion pipe. On the other hand, in a case where the wire solder container member has a tube-like shape in which the wire solder container member has the opening and another opening, it may be arranged so that a wire solder is provided via the another opening of the wire solder container thus provided in the providing step. According to the providing step, an inside of the wire solder container member is in communication with an inside of the optical fiber insertion pipe via the feed hole. This causes the wire solder container member to serve as a feed path (guide) via which the wire solder is fed to the optical fiber insertion pipe.

According to the heating step, the optical fiber insertion pipe is heated to a temperature at which the wire solder is melted. As such, the wire solder in the wire solder container member is melted by the heat conducting from the optical fiber insertion pipe, and then fed to the inside of the optical fiber insertion pipe via the feed hole. Here, the wire solder is contained in the wire solder container member. Thus, even if the wire solder is melted, by the heat conducting from the optical fiber insertion pipe, before being fed to the inside of the optical fiber insertion pipe, it is possible to cause the wire solder to be fed to the feed hole with accuracy, without adhering to the external part of the optical fiber insertion pipe. Thereafter, the wire solder thus melted is fed to the inside of the optical fiber insertion pipe, and fills a space between an inner wall of the optical fiber insertion pipe and the optical fiber by wetting.

According to the method, it is therefore possible to improve a performance of the hermetic sealing by feeding the wire solder with accuracy. This can realize efficient manufacturing of the optical module.

The scope of the present invention further encompasses a method for hermetically sealing an optical fiber insertion pipe in which an optical fiber is inserted, the method including the hermetic sealing step described above.

### Advantageous Effects of Invention

A method of the present invention is a method for manufacturing an optical module including an optical fiber and an optical fiber insertion pipe in which the optical fiber is inserted, the method including a hermetic sealing step in which the optical fiber insertion pipe is hermetically sealed, the hermetic sealing step including: a providing step in which a wire solder container member, (i) which has an opening and (ii) in which a wire solder is contained, is provided to a side surface of the optical fiber insertion pipe so that the opening of the wire solder container member faces a feed hole provided in the side surface of the optical fiber insertion pipe; and a heating step in which the optical fiber insertion pipe is heated to melt the wire solder that is contained in the wire solder container member provided in the providing step. According to the method, it is therefore possible to feed the wire solder with accuracy. This improves performance of the hermetic sealing and thereby realizes efficient manufacturing of the optical module.

### BRIEF DESCRIPTION OF DRAWINGS

FIG. 1 is a cross sectional view showing a hermetic sealing step of a manufacturing method of an optical module in accordance with the present invention.

FIG. 2 is a cross sectional view showing a solder pressing step of the hermetic sealing step shown in FIG. 1.

FIG. 3

(a) of FIG. 3 is a side view showing a lateral side of an optical fiber insertion pipe of the optical module shown in FIG. 1. (b) of FIG. 3 is a top view showing a top of the optical fiber insertion pipe.

FIG. 4 is a cross sectional view showing a modification example of a guide for use in the hermetic sealing step shown in FIG. 1.

FIG. 5

(a) of FIG. 5 is a fragmentary cross sectional view showing another modification example of the guide used in the sealing step shown in FIG. 1. (b) of FIG. 5 is a cross sectional view taken in a plane orthogonal to a plane in which the fragmentary cross sectional view of (a) of FIG. 5 is taken.

FIG. 6

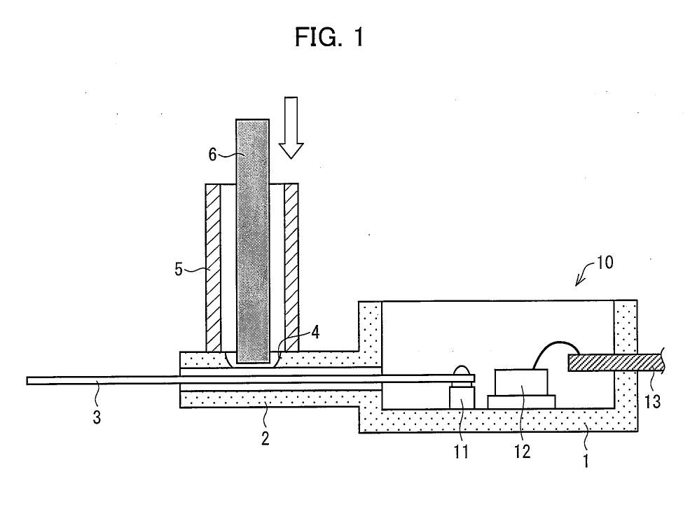

(a) of FIG. 6 is a fragmentary cross sectional view showing still another example of the guide used in the sealing step shown in FIG. 1. (b) of FIG. 6 is a cross sectional view taken in a plane orthogonal to a plane in which the fragmentary cross section of (a) of FIG. 6 is taken.

### DESCRIPTION OF EMBODIMENTS

One embodiment of the present invention is described in detail below.

[Optical module 10]

With reference to FIG. 1, the following description discusses an optical module 10 to be treated in a hermetic sealing step in a method of the present embodiment for manufacturing an optical module. FIG. 1 is a cross sectional view showing the hermetic sealing step.

As shown in FIG. 1, the optical module 10 includes a light-emitting device 12, a housing 1, an optical fiber insertion pipe 2, and an optical fiber 3.

The housing 1 is an optical device package in which the light-emitting device 12 can be housed and fixed. The optical fiber insertion pipe 2 extends out from a side surface of the housing 1.

The optical fiber insertion pipe 2 is a pipe shaped tabular. The optical fiber insertion pipe 2 is provided to extend out from the side surface of the housing 1 so that one end of the optical fiber insertion pipe 2 opens inside the housing 1, whereas the other end of the optical fiber insertion pipe 2 opens outside the housing 1. A feed hole 4 for a wire solder 6 is provided in a side surface of the optical fiber insertion pipe 2. It is preferable that the optical fiber insertion pipe 2 is made from a material, e.g., kovar, which can be effectively heated by high-frequency induction heating (later discussed).

The optical fiber 3 is inserted into the housing 1 through the optical fiber insertion pipe 2. The optical fiber 3 and the light-emitting device 12 are optically connected to each other by aligning their respective optical axes to each other. The optical fiber 3 may be held in the housing 1 by a mount 11. A metallized fiber can be suitably used as the optical fiber 3.

A device such as, for example, an LD chip can be used as the light-emitting device 12. The light-emitting device 12 can be connected, via a line, to a lead 13 inserted into the housing 1 from an outside.

Note that a shape, a structure, a size, and the like of each constituent described so far are not limited to a specific shape, structure, size, and the like. They can be selected appropriately as usage and/or appropriately in accordance with a use purpose of the optical module 10.

[Method of Manufacturing]

The method of the present embodiment for manufacturing an optical module includes a hermetic sealing step in which the optical fiber insertion pipe 2 of the optical module 10 is hermetically sealed. The hermetic sealing step should include: (a) a providing step in which a guide (wire solder container member) 5 that has an opening is provided to the optical fiber insertion pipe 2 so that the opening of the guide 5 faces the feed hole 4 provided in the side surface of the optical fiber insertion pipe 2; and (b) a heating step in which the optical fiber insertion pipe 2 is heated so that the wire solder 6, which is contained in the guide 5 provided in the providing step, is melted. The wire solder 6 which is melted in the heating step is fed to the inside of the optical fiber insertion pipe 2 through the feed hole 4, and this achieves hermetical sealing of the optical fiber insertion pipe 2.

With reference to FIG. 1, the following description discusses (a) the providing step and (b) the heating step included in the hermetic sealing step.

[Providing Step]

According to the providing step, the guide 5 is provided to the optical fiber insertion pipe 2 so that the opening of the guide 5 faces the feed hole 4.

The guide 5 may have (i) a container-like shape in which the guide 5 has a single opening or (ii) a tube-like shape in which the container 5 has two (2) openings (another opening in addition to the opening). Here, the guide 5 exemplified in FIG. 1 has the tube-like shape. In this case, the guide 5 can be provided to the optical fiber insertion pipe 2 before or after the wire solder 6 is contained in the guide 5.

It is preferable that an inner part of the guide 5 is a columnar space. Further, it is preferable that a diameter of the opening of the guide 5 is greater than a diameter of the wire solder 6 but smaller than a diameter of the optical fiber insertion pipe 2 so that the wire solder 6 can be suitably fed.

It is preferable to use, as a material of the guide 5, a material which is hard to be induction heated, e.g., copper, aluminum, ceramic, or glass. By employing the guide 5 that is made from such a material, it is possible in the heating step (later discussed) to (i) prevent induction heating of the guide 5 and (ii) thereby prevent the wire solder 6 in the guide 5 from being melted before being fed to the optical fiber insertion pipe 2. This allows suitable feeding of the wire solder 6.

According to the providing step, the guide 5 is provided as a feed path via which the wire solder 6 is fed to the optical fiber insertion pipe 2.

[Heating Step]

According to the heating step, the optical fiber insertion pipe 2 is heated so that the wire solder 6, which is contained in the guide 5 provided in the providing step, is melted.

It is preferable to heat the optical fiber insertion pipe 2 by using a high-frequency induction heating apparatus. Basically, the high-frequency induction heating apparatus (i) includes an AC power source and a work coil and (ii) heats a workpiece material by inducing an eddy current within the workpiece material. By employing high-frequency induction heating, it is possible to heat the workpiece material (the optical fiber insertion pipe 2 of the present Specification) with accuracy and in a short time.

Note that, in regard to the heating of the optical fiber insertion pipe 2, the present invention is not limited to the high-frequency induction heating. Instead of the high-frequency induction heating, a heating method other than the high-frequency induction heating can be used.

A general and inexpensive wire solder can be used as the wire solder 6. The wire solder 6 may be cut to such a length that (i) an amount of solder required to carry out single hermetic sealing is obtained or (ii) an amount of solder required to carry out multiple hermetic sealings is obtained.

In a case where the feed hole 4 is provided in a top surface of the optical fiber insertion pipe 2, the wire solder 6 in the guide 5 moves, by its own weight, toward the feed hole 4 (see FIG. 1). Also, as discussed later, it is possible to apply a force to the wire solder 6 in the guide 5 in a direction toward the feed hole 4.

According to the heating step, the wire solder 6 which moves closer to the feed hole 4 is heated and melted by a heat conducting from the optical fiber insertion pipe 2 being heated. In this case, since the wire solder 6 is supplied through the guide 5, it is even possible to cause the wire solder 6 thus melted to reach the feed hole 4 with accuracy, without adhering to an outer surface of the optical fiber insertion pipe 2. The wire solder 6 which has reached the feed hole 4 is fed through the feed hole 4 to the inside of the optical fiber insertion pipe 2, while being melted. Thereafter, the wire solder 4 thus melted spreads inside the optical fiber insertion pipe 2 by wetting so as to fill a space between an inner wall of the optical fiber insertion pipe 2 and the optical fiber 3. This can hermetically seal the optical fiber insertion pipe 2 at a good performance level.

Note that, after the hermetic sealing of the optical fiber insertion pipe 2, it is possible to remove the guide 5 from the light fiber insertion pipe 2.

The hermetic sealing of the optical fiber insertion pipe 2 is thus carried out, and this can provide the optical module 10 as a final product.

[Solder Pressing Step]

If a weight of the wire solder 6 is insufficient, for example, it is impossible in the heating step to let the wire solder 6 be sufficiently in contact with the optical fiber insertion pipe 2 near the feed hole 4, thereby failing to attain a sufficient heat conduction to the wire solder 6 from the optical fiber insertion pipe 2 via a contact part where the optical fiber insertion pipe 2 and the wire solder 6 are in contact with each other. As such, there is a case where the wire solder 6 is not melted, and this makes it impossible to carry out the hermetic sealing.

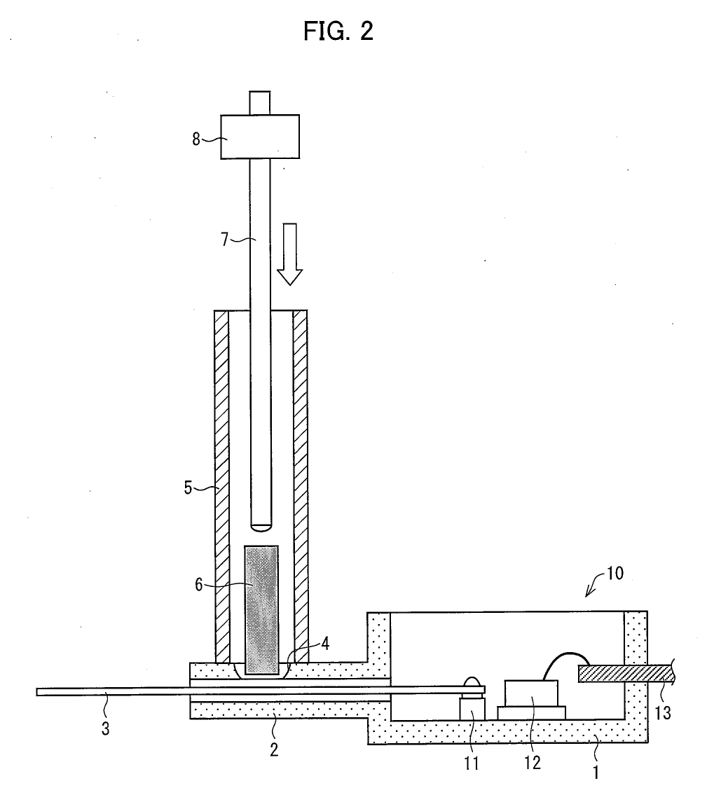

In view of the circumstances, the heating step can include a solder pressing step in which the wire solder 6 in the guide 5 is pressed by a presser bar 7, by inserting the presser bar 7 into one of the two (2) openings of the guide 5 which one is opposite to the other one of the two (2) openings which faces the feed hole 4. The following description discusses the solder pressing step with reference to FIG. 2. FIG. 2 is a cross sectional view showing the solder pressing step.

According to the solder pressing step, the presser bar 7 applies a force on the wire solder 6 in the guide 5 in a direction shown by the arrow in FIG. 2, so as to promote the feeding of the wire solder 6 to the feed hole 4. Further, it is also possible to feed the wire solder 6 while pressing the presser bar 7 against the wire solder 6, irrespective of where the feed hole 4 is located on the side surface of the optical fiber insertion pipe 2.

It is preferable that the presser bar 7 is made from a material, e.g., glass or ceramic, which has a poor thermal conductivity. By employing the presser bar 7 that is made from such a material, it is possible to prevent such heat conduction that the presser bar 7 draws heat from the wire solder 6 to be fed.

The following description discusses one example in which the guide 5 is made from copper and has a cylindrical shape in which (i) an outer diameter of the guide 5 is 2 mm, (ii) an inner diameter of the guide 5 is 1.5 mm, and (iii) a length of the guide 5 is 10 cm. In this case, it is possible to use, as the presser bar 7, a bar that is, for example, made from copper and configured so as to (i) have a columnar shape in which an outer diameter of the bar is 1 mm and a length of the bar is 20 cm and (ii) have a weight of 1.5 g. Also, it is possible to use, as the wire solder 6, a wire solder that is, for example, made from AuSn 90 and configured so as to (i) have a shape in which an outer diameter of the wire solder is 1.2 mm and a length of the wire solder is 5.5 mm, and (ii) have a weight of 0.05 g.

One of tip parts of the presser bar 7, which one is provided at an end pushed against the wire solder 6, may have an intended shape (the one of the tip parts of the presser bar 7 is hereinafter referred to as a bottom tip part). For example, in a case where the bottom tip part of the presser bar 7 is outwardly rounded, it is possible to cause the presser bar 7 to (i) press down the wire solder 6 entirely into the optical fiber insertion pipe 2 and (ii) prevent the wire solder 6 thus pressed down from being raised from and hardened at an outer circumstance of the optical fiber insertion pipe 2. On the other hand, in a case where the bottom tip part of the presser bar 7 is inwardly rounded, it is possible to cause the presser bar 7 to press down the wire solder 6 into the optical fiber insertion pipe 2 so that, in the feed hole 4, the wire solder 6 thus pressed down can be shaped along the side surface of the optical fiber insertion pipe 2 and hardened as such.

The presser bar 7 can be used independently. However, it is preferable to fix a stopper 8 to a part of the presser bar 7 which part is opposite to the bottom tip part and extends outside the guide 5 (see FIG. 2). The stopper 8 will be in contact with a lip of the guide 5 in a case where the presser bar 7 is moved in a direction shown by the arrow in FIG. 2. Thus, the stopper 8 serves to prevent the bottom tip part of the presser bar 7 from being moved beyond the feed hole 4. This can prevent the presser bar 7 from damaging the optical fiber 3.

The stopper 8 may include a touch sensor (not shown in the drawings) which is remote connected to a high-frequency induction heating apparatus. For example, when the touch sensor detects that the stopper 8 is in contact with a lip of the guide 5, the touch sensor sends, to the high-frequency induction heating apparatus, a signal that causes the high-induction heating apparatus to stop heating the optical fiber insertion pipe 2.

(Shape of Feed Hole 4)

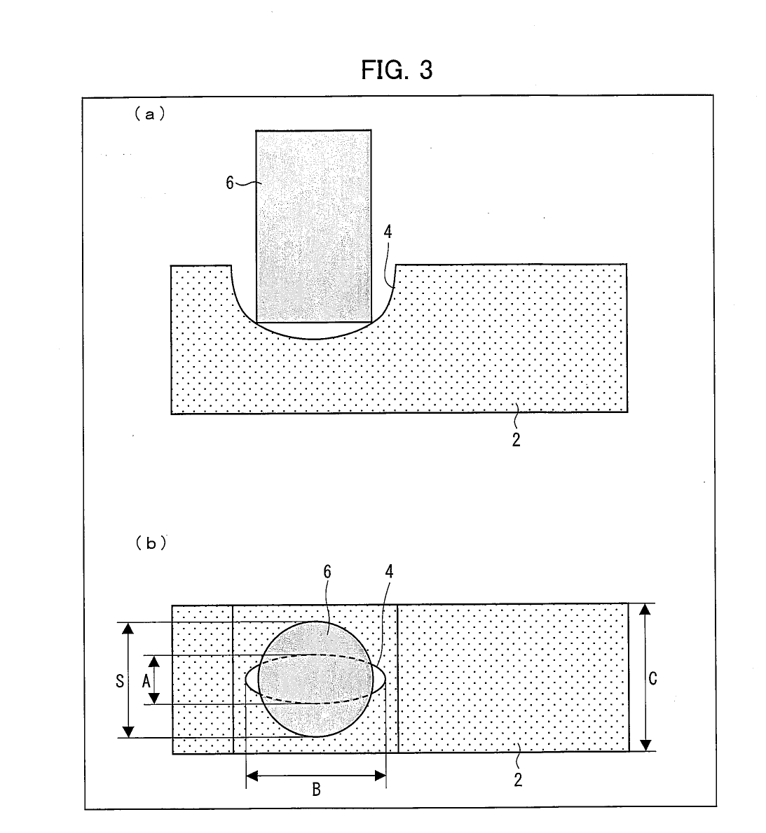

A shape of the feed hole 4 can be determined according to the size of the wire solder 6 for use in the heating step. The following description discusses the shape of the feed hole 4 with reference to FIG. 3. (a) of FIG. 3 is a side view showing the feed hole 4 in an exaggerated manner. (b) of FIG. 3 is a top view showing the feed hole 4 and its neighboring area in an exaggerated manner.

In a case where the shape of the feed hole 4 is an ellipse, for example, it is preferable that a minor axis A of the feed hole 4 is smaller than a diameter S of the solder wire 6 (see (a) and (b) of FIG. 3).

On the other hand, in a case where the shape of the feed hole 4 is a perfect circle, it is preferable that a diameter of the feed hole 4 is smaller than the diameter S of the wire solder 6.

Note that, in either case, it is preferable that a size of the wire solder 6, which is fed in the heating step, is smaller than a diameter C of the optical fiber insertion pipe 2.

In a case where the diameter or the minor axis of the shape of the feed hole 4 is greater than the diameter S of the wire solder 6, there is a risk that, in the heating step, the wire solder 6 which is not yet melted is passed through the feed hole 4 to be fed inside the optical fiber insertion pipe 2. The wire solder 6 is very hard when it is in a solid state. As such, particularly in a case where the optical fiber 3 inserted in the optical fiber insertion pipe 2 is a bare fiber, the optical fiber 3 may be damaged or disconnected by the unmelted wire solder 6 fed inside the optical fiber insertion pipe 2. Furthermore, in a worst case, there is a chance that the optical fiber 3 is broken. On the other hand, in a case where there is employed the wire solder 6 whose diameter is greater than the diameter C of the optical fiber insertion pipe 2, the wire solder 6 is not fed successfully to the inside of the optical fiber insertion pipe 2, and is spilled to an outside of the optical fiber insertion pipe 2.

In this case, however, the feed hole 4 having a shape as shown in (a) and (b) of FIG. 3 makes it possible in the heating step to make sure that no wire solder 6 before being melted is fed to the inside of the optical fiber insertion pipe 2 via the feed hole 4, and that the wire solder 6 after being melted can be successfully fed to the inside of the optical fiber insertion pipe 2 through the feed hole 4.

The shape of the feed hole 4 is not limited to the ellipse or the perfect circle and can be designed to be any. Meanwhile, it is preferable that the feed hole 4 has a shape and/or size to prevent the unmelted wire solder 6 from passing through the feed hole 4.

(Modification Example of Guide 5)

The guide 5 for use in the method of the present invention is not limited to the configuration discussed above. The following description discusses a modification example of the guide 5.

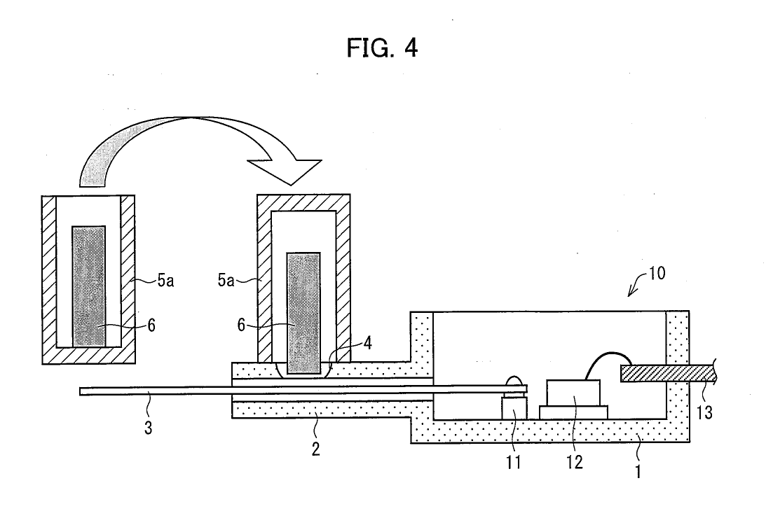

First, it is possible to employ a guide 5a which has a container-like shape (see FIG. 4). FIG. 4 is a cross sectional view showing the sealing step in which the guide 5a is employed. In this case, it is possible in the providing step to provide, to the optical fiber insertion pipe 2, the guide 5a in which the wire solder 6 in an amount required to conduct the hermetic sealing is contained in advance. This causes the guide 5a to, like the guide 5, serve as a guide via which the wire solder 6 is fed to the inside of the optical fiber insertion pipe 2.

The guide 5 may have a function to absorb a heat from the optical fiber insertion pipe 2 via a contact part at which the guide 5 and the optical fiber insertion pipe 2 are in contact with each other. Therefore, it is preferable that the guide 5 is made from a material, such as ceramic or copper, which has a greater thermal conductivity and is difficult to be heated by induction heating. Also, it is preferable that the guide 5 is shaped so as to be able to be suitably in contact with the optical fiber insertion pipe 2.

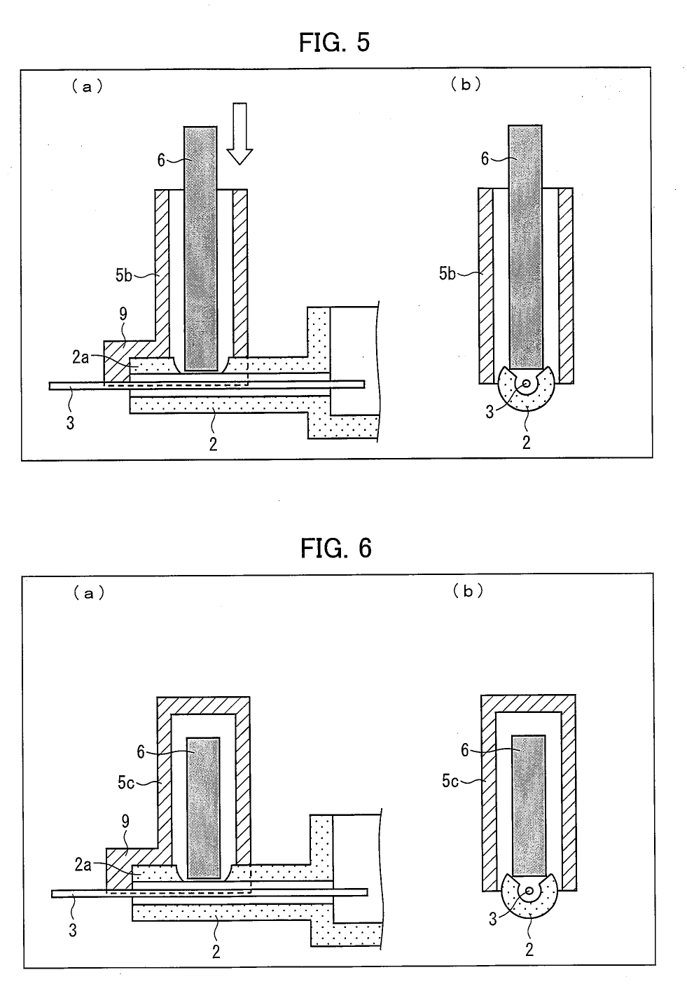

It is possible to use a guide 5b whose (i) guide body, which has a tube-like shape, and (ii) plate section (heat absorbing section) 9 are integrated to be a single member (see (a) and (b) of FIG. 5). (a) of FIG. 5 is a cross sectional view showing how a hermetic sealing step is carried out in which the guide 5b is used. (b) of FIG. 5 is a cross sectional view taken in a plane which is orthogonal to a plane in which the cross sectional view of (a) of FIG. 5 is taken and which passes through a center of the wire solder 6 shown in (a) of FIG. 5.

Alternatively, it is possible to use a guide 5c whose (i) guide body, which has a container-like shape, and (ii) plate section 9 are integrated to be a single member (see FIG. 6). (a) of FIG. 6 is a fragmentary cross sectional view showing a hermetic sealing step in which the guide 5c is used. (b) of FIG. 6 is a cross sectional view taken in a plane which is orthogonal to a plane in which the fragmentary cross sectional view of (a) of FIG. 6 is taken and which passes through a center of the wire solder 6 shown in (a) of FIG. 6.

In a case where the guide 5b or 5c is employed, it is possible in the providing step to cause the plate section 9 to be in contact with an end part 2a of the optical fiber insertion pipe 2 which end part 2a is opposite to an end part continuing to the housing 1. Thus, in the heating step carried out after the providing step, the plate section 9 prevents an excessive increase in the temperature of the end part 2a of the optical fiber insertion pipe 2 by drawing heat from the end part 2a of the optical fiber insertion pipe 2 being heated. This prevents the wire solder 6 thus melted from being spread to the end part 2a of the optical fiber insertion pipe 2 by wetting. It is therefore possible to carry out better hermetic sealing.

Note that a location and a size of the plate section 9 are not limited to the location and the size discussed above, and it is possible to determine an appropriate location and size of the wire solder 6 so that a region in which the wire solder 6 is spread by wetting can be appropriate.

It is preferable to make the plate section 9 from a material having a greater thermal conductivity, so as to realize good heat drawing of the plate section 9. Note, however, that, in a case where the optical fiber insertion pipe 2 is in direct contact with a metal material of the plate section 9, i.e., metals are in contact with each other, an electric current flows from the optical fiber insertion pipe 2 to the plate section 9 via a contact part at which the optical fiber insertion pipe 2 and the plate section 9 are in contact with each other. The application of the current at the contact generates heat locally to the contact part due to a contact resistance. In view of the circumstances, it is possible to suitably use, as the material of the plate section 9, (i) ceramic or (ii) a metal material partially coated with an insulating film (e.g., an oxide film) so that the insulating film coats at least part of the plate section 9, which part is to be in contact with the optical fiber insertion pipe 2.

It is preferable that a material of the guide 5b (5c) is selected in consideration of roles of both the guide 5b (5c) itself and the plate section 9 of the guide 5b (5c), provided that the guide 5b (5c) and the plate section 9 of the guide 5b (5c) are integrated with each other. For example, the guide 5b (5c) can be suitably made from a material such as (i) ceramic or (ii) copper partially coated with an insulating film so that the insulating film coats the plate section 9 of the guide 5b (5c).

### [Summary]

As discussed so far, in order to attain the object, a method of the present invention for manufacturing an optical module is a method for manufacturing an optical module including an optical fiber and an optical fiber insertion pipe in which the optical fiber is inserted, the method including a hermetic sealing step in which the optical fiber insertion pipe is hermetically sealed, the hermetic sealing step including: a providing step in which a wire solder container member, (i) which has an opening and (ii) in which a wire solder is contained, is provided to a side surface of the optical fiber insertion pipe so that the opening of the wire solder container member faces a feed hole provided in the side surface of the optical fiber insertion pipe; and a heating step in which the optical fiber insertion pipe is heated to melt the wire solder that is contained in the wire solder container member provided in the providing step.

For example, in a case where the wire solder container member has a container-like shape in which the wire solder container member has a single opening, it may be arranged so that in the providing step, the solder container member in which the wire solder is contained in advance is provided to the side surface of the optical fiber insertion pipe. On the other hand, in a case where the wire solder container member has a tube-like shape in which the wire solder container member has the opening and another opening, it may be arranged so that a wire solder is provided via the another opening of the wire solder container thus provided in the providing step. According to the providing step, an inside of the wire solder container member is in communication with an inside of the optical fiber insertion pipe via the feed hole. This causes the wire solder container member to serve as a feed path (guide) via which the wire solder is fed to the optical fiber insertion pipe.

According to the heating step, the optical fiber insertion pipe is heated to a temperature at which the wire solder is melted. As such, the wire solder in the wire solder container member is melted by the heat conducting from the optical fiber insertion pipe, and then fed to the inside of the optical fiber insertion pipe via the feed hole. Here, the wire solder is contained in the wire solder container member. Thus, even if the wire solder is melted, by the heat conducting from the optical fiber insertion pipe, before being fed to the inside of the optical fiber insertion pipe, it is possible to cause the wire solder to be fed to the feed hole with accuracy, without adhering to the external part of the optical fiber insertion pipe. Thereafter, the wire solder thus melted is fed to the inside of the optical fiber insertion pipe, and fills a space between an inner wall of the optical fiber insertion pipe and the optical fiber by wetting.

According to the method, it is therefore possible to improve a performance of the hermetic sealing by feeding the wire solder with accuracy. This can realize efficient manufacturing of the optical module.

According to the method of the present invention for manufacturing the optical module, it is preferable that in the heating step, the optical fiber insertion pipe is heated by induction heating.

The heating by the induction heating has an advantage that (i) a temperature of a heating target is increased soon after a start of the heating, and (ii) the heat target is uniformly heated. Thus, by heating the optical fiber insertion pipe by the induction heating, it is possible to melt the wire solder with certainty in a short time.

Furthermore, according to the method of the present invention, it is preferable that: the wire solder container member has a tube-like shape in which both ends of the wire solder container member are opened to have the opening and an another opening; and in the heating step, a bar is inserted into the another opening of the wire solder container member so as to press down the wire solder which is contained in the wire solder container member.

According to the method, the bar applies a force to the wire solder in a direction toward the feed hole, and this can improve feeding of the melted wire solder to the feed hole.

Furthermore, according to the method of the present invention, it is preferable that in the providing step, the wire solder container member is provided to the side surface of the optical fiber insertion pipe so as to be in contact with the optical fiber insertion pipe in order to absorb heat conducting from the optical fiber insertion pipe.

According to the method, in the heating step, the wire solder container member prevents an excessive increase in the temperature of the optical fiber insertion pipe by drawing the heat from the optical fiber insertion pipe being heated. This prevents the wire solder thus fed to the inside of the optical fiber insertion pipe from spreading to an inappropriate region by wetting. It is therefore possible to carry out suitable hermetic sealing by filling, with the wire solder, the space between inner wall of the optical fiber insertion pipe and the optical fiber.

Furthermore, according to the method of the present invention, it is preferable that: the wire solder container member includes a heat absorbing section; and in the providing step, the wire solder container member is provided to the side surface of the optical fiber insertion pipe so that the heat absorbing section is in contact with the optical fiber insertion pipe in order to absorb heat conducing from the optical fiber insertion pipe.

According to the method, in the heating step, the heat absorbing section prevents an excessive increase in the temperature of the optical fiber insertion pipe by drawing the heat from the optical fiber insertion pipe being heated. This prevents the wire solder thus fed to the inside of the optical fiber insertion pipe from spreading to an inappropriate region by wetting. It is therefore possible to carry out suitable hermetic sealing by filling, with the wire solder, the space between inner wall of the optical fiber insertion pipe and the optical fiber.

Furthermore, according to the method of the present invention, it is preferable that the heat absorbing section is made from (i) ceramic or (ii) a metal material partially coated with an insulating material so that the insulating film coats at least part of the heat absorbing section, which part is to be in contact with the optical fiber insertion pipe.

In a case where the heat absorbing section has an electric conductivity, an electric current induced within the optical fiber insertion pipe flows to the heat absorbing section which is in contact with the optical fiber insertion pipe, and this may generate heat. However, in a case of employing the heat absorbing section made from the material (i) or (ii), it is possible to prevent flowing of such an electric current from the optical fiber insertion pipe to the heat absorbing section. This can avoid a case that heat is generated locally to a connection part where the heat absorbing section and the optical fiber insertion pipe are in contact with each other. As such, the heat absorbing section can carry out suitable drawing of the heat from the optical fiber insertion pipe. According to the method above, it is therefore possible to further improve performance of the hermetic sealing.

Furthermore, according to the method of the present invention, it is preferable that the feed hole has a shape that prevents the wire solder not yet melted from passing through the feed hole.

According to the method, in the heating step, no unmelted wire solder is in contact with the optical fiber inserted into the optical fiber insertion pipe. This can prevent the optical fiber from being damaged.

Furthermore, according to the method of the present invention, it is preferable that the shape of the feed hole is a perfect circle or an ellipse, and a diameter or a minor axis of the shape of the feed hole is smaller than a diameter of the wire solder before the wire solder is melted.

According to the method, it is possible to set a suitable relationship between the shape of the feed hole and the size of the wire solder so as to make sure that no unmelted wire solder is in contact with the optical fiber inserted into the optical fiber insertion pipe. This can successfully prevent damaging of the optical fiber.

The scope of the present invention further encompasses a method for hermetically sealing an optical fiber insertion pipe in which an optical fiber is inserted, the method including any of the hermetic sealing steps described above.

### Advantageous Effects of Invention

A method according to the present invention is a method for manufacturing an optical module including an optical fiber and an optical fiber insertion pipe in which the optical fiber is inserted, the method including a hermetic sealing step in which the optical fiber insertion pipe is hermetically sealed, the hermetic sealing step including: a providing step in which a wire solder container, (i) which has an opening and (ii) in which a wire solder is contained, is provided to a side surface of the optical fiber insertion pipe, so that the opening of the wire solder container member faces a feed hole provided in the side surface of the optical fiber insertion pipe; and a heating step in which the optical fiber insertion pipe is heated to melt the wire solder that is contained in the wire solder container member provided in the providing step. This makes it possible to feed the wire solder with accuracy. It is therefore possible to improve performance of the hermetic sealing and thereby to realize efficient manufacturing of the optical module.

### INDUSTRIAL APPLICABILITY

The present invention is usable as a method for manufacturing an optical module for use in, e.g., an optical communication system.

### REFERENCE SIGNS LIST

1. housing
2. optical fiber insertion pipe
3. optical fiber
4. feed hole
5. guide (wire solder container member)
6. wire solder
7. presser bar (bar)
8. stopper
9. plate section (heat absorbing section)
10. optical module
12. light-emitting device

1. A method for manufacturing an optical module including an optical fiber and an optical fiber insertion pipe in which the optical fiber is inserted, the method comprising:
a hermetic sealing step in which the optical fiber insertion pipe is hermetically sealed, the hermetic sealing step including:
a providing step in which a wire solder container member, (i) which has an opening and (ii) in which a wire solder is contained, is provided to a side surface of the optical fiber insertion pipe so that the opening of the wire solder container member faces a feed hole provided in the side surface of the optical fiber insertion pipe; and
a heating step in which the optical fiber insertion pipe is heated to melt the wire solder, which is contained in the wire solder container member provided in the providing step.

2. The method as set forth in claim 1, wherein:
in the heating step, the optical fiber insertion pipe is heated by induction heating.

3. The method as set forth in claim 2, wherein:
the wire solder container member has a tube-like shape in which both ends of the wire solder container member are opened to have the opening and an another opening; and
in the heating step, a bar is inserted into the another opening of the wire solder container member so as to press the wire solder which is contained in the wire solder container member.

4. The method as set forth in claim 2, wherein:
in the providing step, the wire solder container member is provided to the side surface of the optical fiber insertion pipe so as to be in contact with the optical fiber insertion pipe in order to absorb heat conducting from the optical fiber insertion pipe.

5. The method as set forth in claim 2, wherein:
the wire solder container member includes a heat absorbing section; and
in the providing step, the wire solder container member is provided to the side surface of the optical fiber insertion pipe so that the heat absorbing section is in contact with the optical fiber insertion pipe in order to absorb heat conducing from the optical fiber insertion pipe.

6. The method as set forth in claim 5, wherein:
the heat absorbing section is made from (i) ceramic or (ii) a metal material partially coated with an insulating material so that the insulating film coats at least part of the heat absorbing section, which part is to be in contact with the optical fiber insertion pipe.

7. The method as set forth in claim 1, wherein:
the feed hole has a shape that prevents the wire solder not yet melted from passing through the feed hole.

8. The method as set forth in claim 7, wherein:
the shape of the feed hole is a perfect circle or an ellipse, and a diameter or a minor axis of the shape of the feed hole is smaller than a diameter of the wire solder before the wire solder is melted.

9. A method for hermetically sealing an optical fiber insertion pipe in which an optical fiber is inserted, the method comprising:
a providing step in which a wire solder container member, (i) which has an opening and (ii) in which a wire solder is contained, is provided to a side surface of the optical fiber insertion pipe so that the opening of the wire solder container member faces a feed hole provided in the side surface of the optical fiber insertion pipe; and
a heating step in which the optical fiber insertion pipe is heated to melt the wire solder that is contained in the wire solder container member provided in the heating step.

10. The method as set forth in claim 2, wherein:
the feed hole has a shape that prevents the wire solder not yet melted from passing through the feed hole.

11. The method as set forth in claim 10, wherein:
the shape of the feed hole is a perfect circle or an ellipse, and a diameter or a minor axis of the shape of the feed hole is smaller than a diameter of the wire solder before the wire solder is melted.

12. The method as set forth in claim 3, wherein:
the feed hole has a shape that prevents the wire solder not yet melted from passing through the feed hole.

13. The method as set forth in claim 12, wherein:
the shape of the feed hole is a perfect circle or an ellipse, and a diameter or a minor axis of the shape of the feed hole is smaller than a diameter of the wire solder before the wire solder is melted.

14. The method as set forth in claim 4, wherein:
the feed hole has a shape that prevents the wire solder not yet melted from passing through the feed hole.

15. The method as set forth in claim 14, wherein:
the shape of the feed hole is a perfect circle or an ellipse, and a diameter or a minor axis of the shape of the feed hole is smaller than a diameter of the wire solder before the wire solder is melted.

16. The method as set forth in claim 5, wherein:
the feed hole has a shape that prevents the wire solder not yet melted from passing through the feed hole.

17. The method as set forth in claim 16, wherein:
the shape of the feed hole is a perfect circle or an ellipse, and a diameter or a minor axis of the shape of the feed hole is smaller than a diameter of the wire solder before the wire solder is melted.

18. The method as set forth in claim 6, wherein:
the feed hole has a shape that prevents the wire solder not yet melted from passing through the feed hole.

19. The method as set forth in claim 18, wherein:
the shape of the feed hole is a perfect circle or an ellipse, and a diameter or a minor axis of the shape of the feed hole is smaller than a diameter of the wire solder before the wire solder is melted.
